(19) United States
(12) Patent Application Publication
(10) Pub. No.: US 2008/0044590 A1
(43) Pub. Date: Feb. 21, 2008

(54) Manufacturing Method of Phosphor Film

(75) Inventors: Tetsuo Tsuchiya, Ibaraki (JP); Tomohiko Nakajima, Ibaraki (JP); Toshiya Kumagai, Ibaraki (JP)

Correspondence Address: HOWSON AND HOWSON, SUITE 210, 501 OFFICE CENTER DRIVE, FT WASHINGTON, PA, 19034, US

(73) Assignee: National Institute of Advanced Industrial Science and Technology, Tokyo (JP)

(21) Appl. No.: 11/839,270

(22) Filed: Aug. 15, 2007

(30) Foreign Application Priority Data
Aug. 21, 2006 (JP) 2006-224627

(51) Int. Cl. C08J 7/18

(52) U.S. Cl. 427/553

(57) ABSTRACT

Provided is a manufacturing method of a high-performance phosphor thin film material that enables a crystallized pervoskite-related Ti, Zr oxide thin film to be formed on a glass or a silicon substrate. This manufacturing method of a phosphor thin film includes a step of forming an organic metal thin film or a metal oxide film obtained by adding at least one element selected from a group comprised of Ce, Pr, Nd, Sm, Eu, Gd, Tb, Dy, Ho, Er, Tm, Yb and Lu to a metal oxide represented with a composition formula of ABO₃, A₂BO₄, A₃B₂O₇ (provided that there may be a deficiency at the A, B, O sites) wherein A is an element selected from Ca, Sr and Ba, and B is a metal element selected from Ti and Zr on a substrate, and a step of irradiating an ultraviolet lamp to the substrate at room temperature and thereafter irradiating an ultraviolet laser thereto while retaining the substrate at a temperature of 400° C. or less. The film is subject to oxidation treatment after being crystallized.

### BACKGROUND

1. Field of the Invention

Pursuant to the advancement of information society centering on the Internet, demands are increasing for flat panel displays (hereinafter referred to as “FPD”) as represented by liquid crystal displays, plasma displays, field emission displays (FED), and organic EL displays, and the development of methods for preparing phosphors for use in such flat panel displays is a crucially important task.

2. Description of the Related Art

A field emission display (hereinafter referred to as “FED”) is a display device based on the fundamental principle of emitting electrons from a planate emitter in a vacuum, and colliding such electrons with phosphor to emit light. In this technology, a device corresponding to an electron gun of a cathode ray tube is formed in a planar shape, and a bright and high-contrast screen like a CRT is realized in a large flat-panel display. With a cathode ray tube, one electron gun that emits electrons is positioned a dozen to several ten centimeters away from the light-emitting surface. Meanwhile, with FED, electrodes in the form of minute protrusions are arranged on a glass substrate in a lattice pattern in an equal number as the number of pixels, and the respective electrodes discharge electrons toward the phosphors that are arranged to face each other in several millimeter intervals on the glass substrate. Since the deflection required in a cathode ray tube is no longer necessary, it is possible to prepare a large flat-screen display, and the power consumption can also be reduced to roughly half of a CRT display. FED is considered to be promising technology that will realize large flat-screen televisions/displays for the next generation along with LCD and PDP.

Among the various phosphors, oxide phosphor is counted on for use as an FED phosphor since it is stable against electron beams. Conventionally, red phosphor was obtained by doping Eu to Y₂O₃, but a phosphor based on SrTiO₃, which is a compound oxide, has been developed as a red glow phosphor for low-energy electron beams (Japanese Patent Laid-Open Publication No. H8-85788; “Patent Document 1”).

In this manufacturing method, a raw material for a preparation of a phosphor is calcinated in an furnace at 1100 to 1400° C. for 1 to 6 hours to prepare particulates. Further, by replacing Sr with Ca, oxide phosphor that has a longer operating life than SrTiO₃:Pr,Al phosphor and which emits high-intensity light even with a low-energy electron beam, and a fluorescent display device have been developed (Japanese Patent Laid-Open Publication No. 2005-281507; “Patent Document 2”).

Nevertheless, since conventional phosphor films were prepared by mixing the obtained particulates with a binder using the screen printing technique, there is a problem in that it is not possible to maintain high luminous efficiency due to the discharge of gas by electron beam irradiation. As one method of overcoming this problem, the possibility of improving characteristics by directly manufacturing a rare-earth phosphor film on a glass substrate is being considered. Still, since the crystallization temperature is normally high, there is a problem in that it is not possible to manufacture such a film on a glass substrate (Journal of Alloys and Compounds, Volume 374, Issues 1-2, 14 Jul. 2004, Pages 202-206; “Non-Patent Document 1”).

As a method of preparing a certain type of metal oxide film, a manufacturing method of a metal oxide and a metal oxide thin film based on an excimer laser, comprising the steps of dissolving metal organic acid salt or an organic metal compound MₘRₙ (provided M=4b group elements of Si, Ge, Sn, Pb; 6a group elements of Cr, Mo, W; 7a group elements of Mn, Tc, Re; R=an alkyl group such as CH₃, C₂H₅, C₃H₇, C₄H₉; or a carboxyl group such as CH₃COO⁻, C₂H₅COO⁻, C₃H₇COO⁻, C₄H₉COO⁻; or a carbonyl group of CO; wherein m and n are integers) in a soluble solvent (or if a liquid, using it as is), dispersively applying such solution on a substrate, and irradiating an excimer laser under an oxygen environment, is known. (Specification of Japanese Patent No. 2759125; “Patent Document 3”).

In addition, there is a method of manufacturing a metal oxide on a substrate without performing heat treatment at a high temperature as performed in a conventional thermal metalorganic deposition (MOD). For instance, a manufacturing method of a metal oxide for forming a metal oxide on a substrate, comprising the steps of dissolving a metal organic compound (metal organic acid salt, metal acetylacetonato, metal alkoxide including an organic group of carbon number 6 or greater) in a solvent to obtain a solution, applying such solution on a substrate, thereafter drying the substrate, and irradiating a laser beam having a wavelength of 400 nm or less, is known. (Japanese Patent Laid-Open Publication No. 2001-31417; “Patent Document 4”).

Patent Document 4 describes a manufacturing method of a metal oxide for forming a metal oxide on a substrate, comprising the steps of dissolving a metal organic compound in a solvent to obtain a solution, applying such solution on a substrate, thereafter drying the substrate, and irradiating a laser beam having a wavelength of 400 nm or less; for instance, an excimer laser selected from ArF, KrF, XeCl, XeF and F₂, and further describes that the irradiation of the laser beam having a wavelength of 400 nm or less is performed in a plurality of stages, wherein the initial stage of irradiation is performed with weak irradiation that will not completely decompose the metal organic compound, and the subsequent stage of irradiation is performed with strong irradiation that will even change the oxide. Further, it is also known that the metal organic compound is a compound comprising two or more types of different metals, the obtained metal oxide is a compound metal oxide comprising different metals, and the metal of the metal organic acid salt is selected from a group comprised of iron, indium, tin, zirconium, cobalt, iron, nickel and lead.

Furthermore, a manufacturing method of a compound oxide film comprising the steps of applying and depositing a precursor coating solution containing a raw material component of the respective oxides of La, Mn and Ca, Sr or Ba on the surface of a coating object, thereafter crystallizing the thin film formed on the coating object surface, and forming a compound oxide film (that does not show superconductivity) having a perovskite structure as represented with the composition formula of (La₁₋ₓMₓ)MnO_{3-δ}(M:Ca, Sr, Ba, 0.09≦x≦0.50), wherein after applying and depositing the precursor coating solution on the surface of the coating object, the thin film is crystallized by irradiating light having a wavelength of 360 nm or less on the thin film formed on the coating object surface, is known. (Japanese Patent Laid-Open Publication No. 2000-256862; “Patent Document 5”).

Here, as the light source for irradiating light on the thin film formed on the coating object surface, ArF excimer laser, KrF excimer laser, XeCI excimer laser, XeF excimer laser, third harmonic generation of YAG laser, or fourth harmonic generation of YAG laser is used, and the precursor coating solution to be applied on the coating object surface is obtained by mixing, reacting and adjusting an alkanolamine coordinate compound of La, carboxylate of Mn, and metal or alkoxide of M in a primary alcohol in which the carbon number is 1 to 4.

### SUMMARY

Nevertheless, there is absolutely no report on the crystal growth caused by laser beam irradiation or the fluorescence property concerning an oxide film formed on a substrate and represented with a metal composition formula of ABO₃, A₂BO₄, A₃B₂O₇ using at least one element selected from A and B, wherein A is Ca, Sr and Ba, and B is Ti and Zr. In the manufacturing method of SrTiO₃:Pr:Al phosphor as a representative phosphor material, a phosphor film was calcinated at high temperature using the sol-gel method or the solid-phase method and formed on a substrate using the screen printing method or the like. In the case of using these processes, it is difficult to form a thin film on a glass because heat treatments at greater than 500° C. are required. Thus, an object of the present invention is to provide a manufacturing method of a high-performance phosphor film material that enables a crystallized SrTiO₃:Pr:Al thin film to be formed on a glass or a silicon substrate by the additional treatment such as a thermal annealing under an oxidation atmosphere, or ultraviolet radiation in a solution and oxygen atmosphere.

In order to achieve the foregoing object, the present invention substitutes a part of the thermal metal organic deposition (MOD) with irradiation of ultraviolet radiation (laser) during the manufacture of a SrTiO₃:Pr:Al thin film. In other words, when manufacturing a SrTiO₃:Pr:Al thin film through process (1) of applying and drying a metal organic compound solution on a support, process (2) of subjecting an organic constituent to thermal decomposition calcination, and process (3) of baking for converting the resultant into a phosphor film, the present invention irradiates ultraviolet (laser) radiation, particularly having a wavelength of 400 nm or less, in parallel with process (2) and process (3), or before process (2). Thereby, low-temperature and high-speed deposition of the phosphor film material (considerable shortening of the thermal treatment time) is enabled, and, by precisely controlling the use of masks and irradiation position of the ultraviolet radiation, patterning required for the device can be conducted simultaneously with the deposition.

In other words, the present invention provides a manufacturing method of a metal oxide phosphor thin film comprising a step of forming a thin film of metal oxide obtained by adding at least one element selected from a group comprised of Ce, Pr, Nd, Sm, Eu, Gd, Tb, Dy, Ho, Er, Tm, Yb and Lu to a metal oxide represented with a composition formula of ABO₃, A₂BO₄, A₃B₂O₇ wherein A is an alkaline-earth metal element selected from Ca, Sr and Ba, and B is a metal element selected from Ti and Zr, or a thin film of organometallic salt capable of forming a metal oxide on a substrate and retaining the substrate at a temperature of 25 to 500° C., and a step of crystallizing the thin film of metal oxide or organometallic salt on the substrate while irradiating ultraviolet radiation thereto so as to form a metal oxide on the substrate.

Moreover, in the present invention, a metal oxide or organometallic salt containing at least one element selected from Al, Ga and In may be further added to the metal oxide or the organometallic salt.

Further, in the present invention, the thin film of metal oxide or organometallic salt may be prepared by MBE, vapor deposition, CVD, or a chemical solution deposition method (spread and thermal deposition method, spray method).

In addition, in the present invention, an organic compound in the organometallic salt may be one type selected from β-diketonato, long-chain alkoxide with carbon number 6 or greater, and organic acid salt that may contain halogen.

Moreover, with the present invention, the ultraviolet radiation may be a pulsed laser of 400 nm or less.

Further, with the present invention, an ultraviolet lamp may be irradiated to the thin film of metal oxide or organometallic salt, and an ultraviolet laser may thereafter be irradiated at a temperature of 200° C. to 400° C. or less.

In addition, with the present invention, the thin film of metal oxide or organometallic salt may be heated at 400° C., and thereafter irradiated with an ultraviolet laser at a temperature of 200° C. to 400° C. or less.

Moreover, with the present invention, the thin film of metal oxide or organometallic salt may be irradiated with an ultraviolet laser at room temperature under a condition combining the conditions of repetition rate and fluence that will not cause an ablation, and may thereafter be irradiated with a laser beam having a fluence of 30 mJ/cm² or greater with a plurality of fluences.

Further, the present invention may also include a step of subjecting a metal oxide film obtained by laser irradiation to oxidation treatment using an oxidizing solution, or oxidation treatment under an oxidation atmosphere based on thermal treatment, or oxidation treatment based on ultraviolet irradiation in a solution and under an oxidizing atmosphere, or oxidation treatment using oxygen plasma.

In addition, with the present invention, the metal oxide may have a metal composition formula of (Ca_{1-x-y}SrₓBa_{y})₃(Ti_{1-z}Zr_{z})₂O₇(Ca_{1-x-y}SrₓBa_{y})₂(Ti_{1-z}Zr_{z})O₄, 0≦x+y≦1, 0≦x≦1, 0≦y≦1, 0≦z≦1 as its base material, and be added with at least one among Ce, Pr, Nd, Sm, Eu, Gd, Tb, Dy, Ho, Er, Tm, Yb and Lu.

Moreover, with the present invention, the metal oxide may further contain one or more elements selected from Al, Ga and In.

The present invention yields a significant effect of forming a phosphor thin film on a glass substrate or a silicon/organic substrate at low temperature, with favorable manufacturing efficiency, and in a manner suitable for mass production that was not possible conventionally. The present invention yields an additional effect in that the phosphor thin film is able to attain superior luminance efficiency.

### DESCRIPTION OF DRAWINGS

FIG. 1 shows the XRD patterns of films prepared by thermal treatment;

FIG. 2 shows the XRD patterns of films prepared by laser beam irradiation of the present invention;

FIG. 3 shows the PL spectra of films prepared by thermal treatment and laser beam irradiation; and

FIG. 4 shows the PL spectra of films after laser irradiation and films that were subject to oxidizing after laser irradiation.

### DETAILED DESCRIPTION

The manufacturing method of a phosphor according to the present invention is characterized in that a metal organic compound solution for forming a phosphor is applied on a support, and the film is irradiated with an ultraviolet laser during the subsequent drying process, calcination process and baking process. A laser beam may be used as the ultraviolet radiation in the present invention.

Depending on the objective, the irradiation process may be performed during a prescribed process, or before or after the respective processes. Further, it is also possible to spin-coat the metal organic compound solution on a substrate, dry the substrate for solvent elimination in a thermostatic bath at 130° C., thereafter mount the sample on a sample holder in a laser chamber, and perform laser irradiation at room temperature.

In the present invention, as the metal for oxide to form a phosphor substance, a precursor film obtained by adding at least one element selected from a group comprised of Ce, Pr, Nd, Sm, Eu, Gd, Tb, Dy, Ho, Er, Tm, Yb and Lu to an oxide represented with a composition formula of ABO₃, A₂BO₄, A₃B₂O₇ (provided that there may be a deficiency at the A, B, O sites) wherein A is Ca, Sr and Ba, and B is Ti and Zr. One among Al, Ga and In may also be added thereto.

The present invention is also effective for a thin film containing minute amounts of conductive substances selected from In₂O₃, SnO₂, ZnO and metal in advance.

As a result of irradiating laser on a film applied with a metal organic compound and thereafter dried and a film at the initial stage of calcinations, and thereafter performing appropriate thermal treatment to these laser irradiated films, for instance, the following effects were confirmed in the case of preparing a CaTiO₃:Pr film.

After the process of applying and drying a metal organic compound solution for preparing a CaTiO₃:Pr film on a support, by irradiating a laser beam at a temperature of 400° C. or lower after the calcination process of thermally decomposing the organic constituent in the metal organic compound at a temperature of 400° C., it has been discovered that crystallization is promoted at a low temperature.

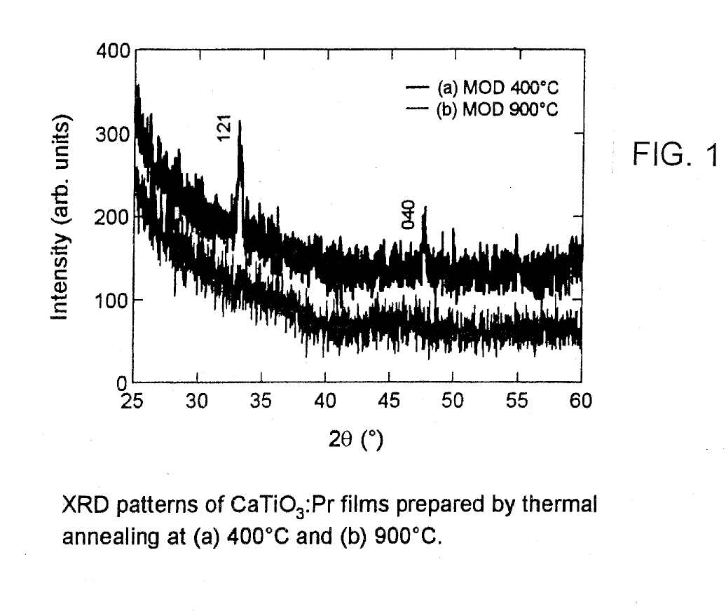

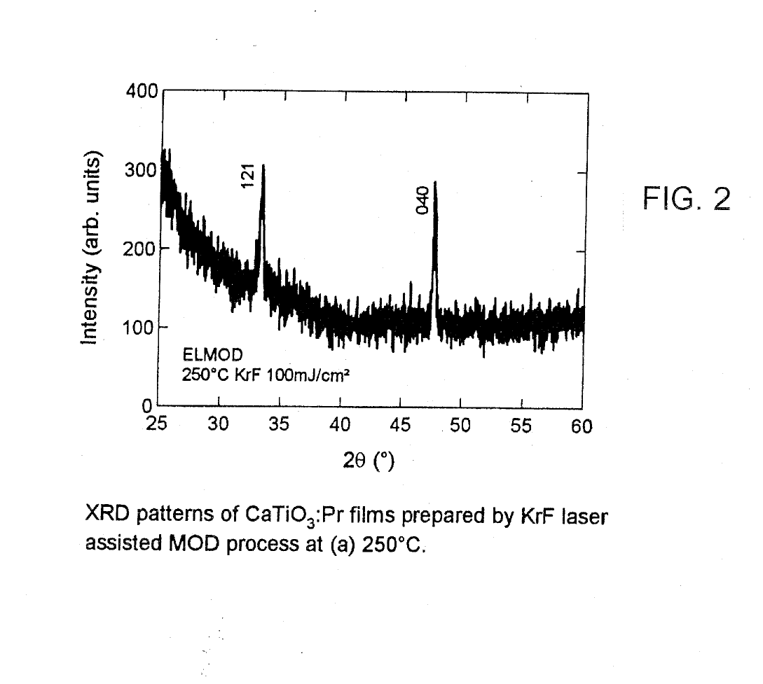

With conventional thermal MOD process for the preparation of oxide film, as shown in FIG. 1, it is known that crystallization will not occur at 400° C., and that the crystallization reaction is promoted at 900° C. With the manufacturing method of a phosphor film of the present invention, thin film crystal growth has been confirmed at a low temperature from room temperature to 400° C. as shown in FIG. 2.

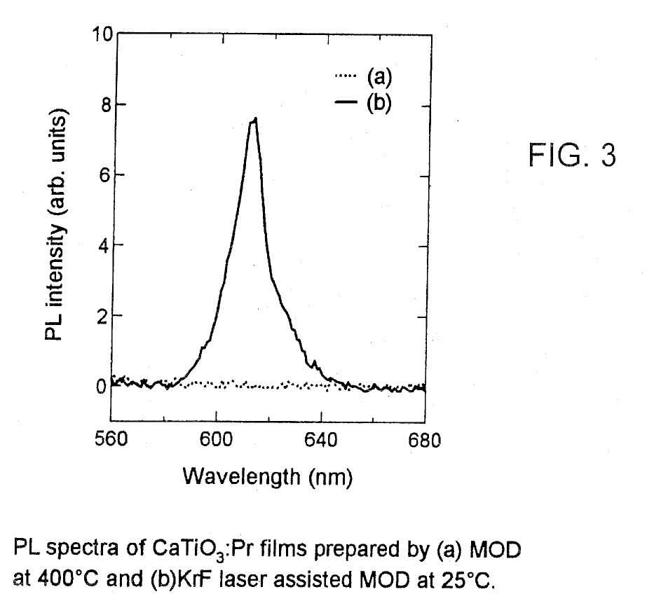

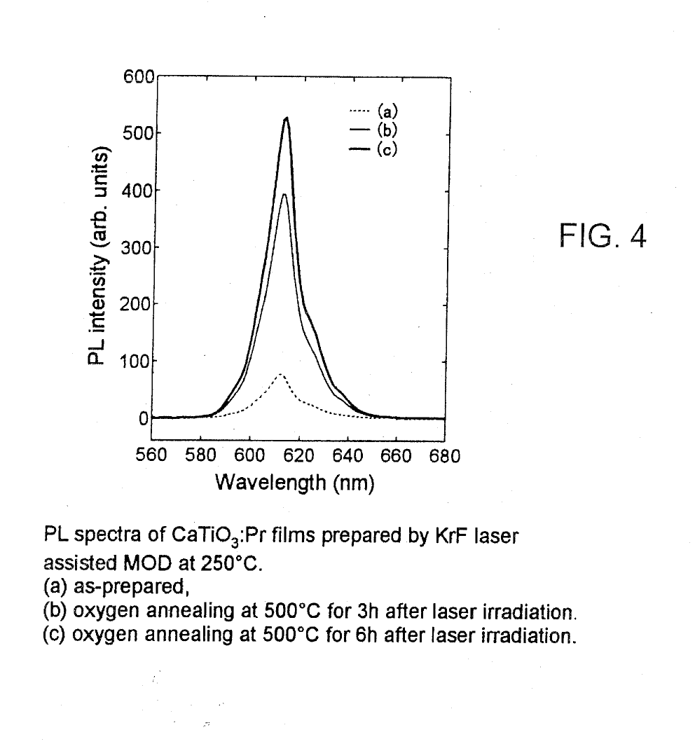

FIG. 3 shows the measurement results of the photoluminescence of a film prepared by the thermal metal organic deposition(MOD) and laser-assisted MOD methods. As shown in FIG. 3, although no light emission can be observed with the film subject to thermal treatment at 400° C., the film additionally subject to laser irradiation emitted light even at room temperature. Although the luminescence intensity will be higher when the temperature during laser irradiation is higher, it has been discovered that the luminescence intensity can be doubled by subjecting the laser irradiated film to oxidation treatment (FIG. 4).

In the present invention, as the support, one type selected from organic substrate, glass substrate, polycrystalline and single crystalline oxide substrates such as strontium titanate (SrTiO₃), lanthanum aluminate (LaAlO₃), magnesium oxide (MgO), lanthalum strontium tantalum aluminum oxide ((LaₓSr₁₋ₓ)(AlₓTa₁₋ₓ)O₃), neodymium gallate (NdGaO₃), yttrium aluminate (YAlO₃), aluminum oxide (Al₂O₃), yttria-stabilized zirconia ((Zr, Y)O₂, YSZ) substrate may be used.

Specific examples of the present invention are now explained in detail below, but the present invention is not limited by these Examples in any way.

A quartz substrate and a non-alkali glass substrate were used as the substrate for the Examples in the present invention, and a solution obtained by mixing a 2-ethyl-1-hexanoate Ti solution to a strontium 2-ethylhexanoate solution was used as the raw material solution. Praseodium 2-ethylhexanoate was also used. KrF excimer laser, ArF excimer laser, and XeCl excimer laser were used for the irradiation of ultraviolet radiation.

### EXAMPLE 1

A 2-ethyl-1-hexanoate Ti solution and praseodium 2-ethylhexanoate were added to a calcium 2-ethylhexanoate solution in a definite proportion to prepare a mixed solution (C1).

The C1 solution was spin-coated on a quartz substrate at 4000 rpm for 10 seconds, and heated at 400° C. for 10 minutes. Subsequently, the substrate temperature was retained at 250° C. and the spin-coated film was irradiated with a pulsed laser of 248 nm, 20 Hz, and at a fluence of 80 mJ/cm² in the atmosphere for 5 minutes. The prepared film showed high luminescence intensity based on ultraviolet excitation only at the irradiated portion.

### EXAMPLE 2

When the spin-coated film was irradiated with laser at a fluence of 100 mJ/cm² in Example 1, only the irradiated portion showed high luminescence intensity based on ultraviolet excitation.

### EXAMPLE 3

When the spin-coated film was irradiated with laser at a fluence of 120 mJ/cm² in Example 1, only the irradiated portion showed high luminescence intensity based on ultraviolet excitation.

### EXAMPLE 4

When the pulse rate of irradiation was set to 50 Hz in Example 1, only the irradiated portion showed high luminescence intensity based on ultraviolet excitation.

### EXAMPLE 5

When the pulse rate of irradiation was set to 10 Hz in Example 1, only the irradiated portion showed high luminescence intensity based on ultraviolet excitation.

### EXAMPLE 6

When the quartz substrate was replaced with an ITO/glass substrate (ITO coated on a glass substrate) in Example 1, a crystallized CaTiO₃:Pr film was obtained at the irradiated portion. Further, only the irradiated portion showed high luminescence intensity based on ultraviolet excitation.

### EXAMPLE 7

When the quartz substrate was replaced with a non-alkali glass substrate in Example 1, only the irradiated portion showed high luminescence intensity based on ultraviolet excitation.

### EXAMPLE 8

When the temperature of calcination to be performed after spin coating was set at 25 to 250° C. in Example 1, although only the irradiated portion showed high luminescence intensity based on ultraviolet excitation, the film crystallinity was inferior compared to a case when the calcination temperature was set to 400° C., and the increase of luminescence intensity after oxygenation was small. Thus, the calcination temperature is preferably around 400° C.

### EXAMPLE 9

A 2-ethyl-1-hexanoate Ti solution and praseodium 2-ethylhexanoate were added to a calcium 2-ethylhexanoate solution at a ratio of Ca:Ti:Pr=1.997:1:0.002 to prepare a mixed solution (C2).

The C2 solution was spin coated on a quartz substrate at 4000 rpm for 10 seconds, and heated at 400° C. for 10 minutes. Subsequently, the substrate temperature was retained at 250° C. and the spin-coated film was irradiated with a pulsed laser of 248 nm, 20 Hz, and a fluence of 80 mJ/cm² in the atmosphere for 5 minutes. As a result, the creation of a Ca₂TiO₄:Pr film was acknowledged by X-ray diffraction. The prepared film showed high luminescence intensity, equivalent to CaTiO₃:Pr, based on ultraviolet excitation only at the irradiated portion.

### EXAMPLE 10

A 2-ethyl-1-hexanoate Ti solution and praseodium 2-ethylhexanoate were added to a calcium 2-ethylhexanoate solution at a ratio of Ca:Ti:Pr=2.994:2:0.004 to prepare a mixed solution (C3).

The C3 solution was spin-coated on a quartz substrate at 4000 rpm for 10 seconds, and heated at 400° C. for 10 minutes. Subsequently, the substrate temperature was retained at 250° C. and the spin-coated film was irradiated with a pulsed laser of 248 nm, 20 Hz, and a fluence of 80 mJ/cm² in the atmosphere for 5 minutes. As a result, the creation of a Ca₃Ti₂O₇:Pr film was acknowledged by X-ray diffraction. The luminescence intensity of the prepared film was six times that of the CaTiO₃:Pr film.

### EXAMPLE 11

A 2-ethyl-1-hexanoate Ti solution and praseodium 2-ethylhexanoate were added to a strontium 2-ethylhexanoate solution at a ratio of Sr:Ti:Pr=0.998:1:0.002 to prepare a mixed solution (S1).

The S1 solution was spin-coated on a quartz substrate at 4000 rpm for 10 seconds, and heated at 400° C. for 10 minutes. Subsequently, the substrate temperature was retained at 250° C. and the spin-coated film was irradiated with a pulsed laser of 248 nm, 20 Hz, and a fluence of 80 mJ/cm² in the atmosphere for 5 minutes. As a result, the formation of a SrTiO₃:Pr film was identified by X-ray diffraction. Only the irradiated portion of the prepared film emitted light.

### EXAMPLE 12

A 2-ethyl-1-hexanoate Ti solution, praseodium 2-ethylhexanoate, and an aluminum acetylacetonate solution were added to a strontium 2-ethylhexanoate solution at a ratio of Sr:Ti:Pr:Al 1:1:0.002:0.15 to prepare a mixed solution (S2).

The S2 solution was spin-coated on a quartz substrate at 4000 rpm for 10 seconds, and heated at 400° C. for 10 minutes. Subsequently, the substrate temperature was retained at 250° C. and the spin-coated film was irradiated with a pulsed laser of 248 nm, 20 Hz, and a fluence of 80 mJ/cm² in the atmosphere for 5 minutes. As a result, the formation of a SrTiO₃:Pr,Al film was identified by X-ray diffraction. Only the irradiated portion of the prepared film emitted light.

### EXAMPLE 13

A 2-ethyl-1-hexanoate Ti solution and praseodium 2-ethylhexanoate were added to a strontium 2-ethylhexanoate solution at a ratio of Sr:Ti:Pr=2:1:0.002 to prepare a mixed solution (S3).

The S3 solution was spin coated on a quartz substrate at 4000 rpm for 10 seconds, and heated at 400° C. for 10 minutes. Subsequently, the substrate temperature was retained at 250° C. and the spin-coated film was irradiated with a pulsed laser of 248 nm, 20 Hz, and a fluence of 80 mJ/cm² in the atmosphere for 5 minutes. As a result, the formation of a Sr₂TiO₄:Pr film was identified by X-ray diffraction. Only the irradiated portion of the prepared film emitted light.

### EXAMPLE 14

A 2-ethyl-1-hexanoate Ti solution and praseodium 2-ethylhexanoate were added to a strontium 2-ethylhexanoate solution at a ratio of Sr:Ti:Pr=3:2:0.004 to prepare a mixed solution (S4).

The S4 solution was spin coated on a quartz substrate at 4000 rpm for 10 seconds, and heated at 400° C. for 10 minutes. Subsequently, the substrate temperature was retained at 250° C. and the spin-coated film was irradiated with a pulsed laser of 248 nm, 20 Hz, and a fluence of 80 mJ/cm² in the atmosphere for 5 minutes. As a result, the formation of a Sr₃Ti₂O₇:Pr film was identified by X-ray diffraction. Only the irradiated portion of the prepared film emitted light.

### EXAMPLE 15

A strontium 2-ethylhexanoate solution, a 2-ethyl-1-hexanoate Ti solution, and praseodium 2-ethylhexanoate were added to a calcium 2-ethylhexanoate solution at a ratio of Ca:Sr:Ti:Pr=2:1:2:0.002 to prepare a mixed solution (S5).

The S5 solution was spin coated on a quartz substrate at 4000 rpm for 10 seconds, and heated at 400° C. for 10 minutes. Subsequently, the substrate temperature was retained at 250° C. and the spin-coated film was irradiated with a pulsed laser of 248 nm, 20 Hz, and a fluence of 80 mJ/cm² in the atmosphere for 5 minutes. As a result, the formation of a (Ca, Sr)₃Ti₂O₇:Pr film was identified by X-ray diffraction. Only the irradiated portion of the prepared film emitted light.

### EXAMPLE 16

The C1 solution was spin coated on a quartz substrate at 4000 rpm for 10 seconds, and irradiated with an ultraviolet lamp at room temperature for 10 minutes. Subsequently, the substrate temperature was retained at 250° C. and the spin-coated film was irradiated with a pulsed laser of 248 nm, 20 Hz, and a fluence of 80 mJ/cm² in the atmosphere for 5 minutes. As a result, the formation of a CaTiO₃:Pr film was identified by X-ray diffraction. Only the irradiated portion of the prepared film emitted light.

### COMPARATIVE EXAMPLE 1

The C1 solution was spin-coated on a quartz substrate at 3000 rpm for 10 seconds, and heated at 400° C. for 10 minutes. As a result, the deposited film did not emit light.

### COMPARATIVE EXAMPLE 2

The C1 solution was spin-coated on non-alkali glass at 3000 rpm for 10 seconds, and heated at 400° C. for 10 minutes. As a result, the deposited film did not emit light.

### COMPARATIVE EXAMPLE 3

The C1 solution was spin-coated on an ITO/quartz substrate at 3000 rpm for 10 seconds, and heated at 400° C. for 10 minutes. As a result, the deposited film did not emit light.

What is claimed is:

1. A manufacturing method of a metal oxide phosphor thin film, comprising:
a step of forming a thin film of metal oxide obtained by adding at least one element selected from a group comprised of Ce, Pr, Nd, Sm, Eu, Gd, Tb, Dy, Ho, Er, Tm, Yb and Lu to a metal oxide represented with a composition formula of ABO₃, A₂BO₄, A₃B₂O₇ wherein A is an alkaline-earth metal element selected from Ca, Sr and Ba, and B is a metal element selected from Ti and Zr, or a thin film of organometallic salt capable of forming a metal oxide on a substrate and retaining said substrate at a temperature of 25 to 500° C.; and
a step of crystallizing said metal oxide or said thin film of organometallic salt on said substrate while irradiating ultraviolet radiation thereto so as to form a metal oxide on said substrate.

2. The manufacturing method of a metal oxide phosphor thin film according to claim 1, wherein a metal oxide or organometallic salt containing at least one element selected from Al, Ga and In is further added to said metal oxide or said organometallic salt.

3. The manufacturing method of a metal oxide phosphor thin film according to claim 1 or claim 2, wherein said thin film of metal oxide or organometallic salt is prepared by MBE, vacuum deposition, CVD, or a chemical solution deposition method (spin-coating or spray coating methods).

4. The manufacturing method of a metal oxide phosphor thin film according to claim 1 or claim 2, wherein an organic compound in said organometallic salt is one type selected from β-diketonato, long-chain alkoxide with carbon number 6 or greater, and organic acid salt that may contain halogen.

5. The manufacturing method of a metal oxide phosphor thin film according to claim 1 or claim 2, wherein said ultraviolet radiation is a pulsed laser of 400 nm or less.

6. The manufacturing method of a metal oxide phosphor thin film according to claim 1 or claim 2, wherein an ultraviolet lamp is irradiated to said thin film of metal oxide or organometallic salt, and an ultraviolet laser is thereafter irradiated at a temperature of 200° C. to 400° C. or less.

7. The manufacturing method of a metal oxide phosphor thin film according to claim 1 or claim 2, wherein said thin film of metal oxide or organometallic salt is heated at 400° C., and thereafter irradiated with an ultraviolet laser at a temperature of 200° C. to 400° C. or less.

8. The manufacturing method of a metal oxide phosphor thin film according to claim 1 or claim 2, wherein said thin film of metal oxide or organometallic salt is irradiated with an ultraviolet laser at room temperature under a condition combining the conditions of repetition rate and fluence that will not cause an abrasion, and thereafter irradiated with a laser beam having a fluence of 30 mJ/cm² or greater with a plurality of fluences.

9. A manufacturing method of a phosphor metal oxide thin film, comprising:
a step of subjecting a metal oxide film obtained by laser irradiation to oxidation treatment using an oxidizing solution, or oxidation treatment under an oxidation atmosphere based on thermal treatment, or oxidation treatment based on ultraviolet irradiation in a solution and under an oxidizing atmosphere, or oxidation treatment using oxygen plasma.

10. The manufacturing method of a metal oxide phosphor thin film according to claim 1, wherein said metal oxide has a metal composition formula of (Ca_{1-x-y}SrₓBa_{y})₃(Ti_{1-z}Zr_{z})₂O₇(Ca_{1-x-y}SrₓBa_{y})₂(Ti_{1-z}Zr_{z})O₄, 0≦x+y≦1, 0≦x<1, 0≦y≦1, 0≦z≦1 as its base material, and is added with at least one among Ce, Pr, Nd, Sm, Eu, Gd, Tb, Dy, Ho, Er, Tm, Yb and Lu.

11. The manufacturing method of a metal oxide phosphor thin film according to claim 10, wherein said metal oxide further contains one or more elements selected from Al, Ga and In.
